(19) United States
(12) Patent Application Publication
(10) Pub. No.: US 2022/0146645 A1
(43) Pub. Date: May 12, 2022

(54) FOCAL PLANE ARRAY SYSTEM FOR LIDAR

(71) Applicant: OURS Technology, LLC, Mountain View, CA (US)

(72) Inventors: Andrew Steil Michaels, Santa Clara, CA (US); Sen Lin, Santa Clara, CA (US)

(21) Appl. No.: 17/585,234

(22) Filed: Jan. 26, 2022

Related U.S. Application Data
(63) Continuation of application No. PCT/US2020/043556, filed on Jul. 24, 2020.
(60) Provisional application No. 62/879,383, filed on Jul. 26, 2019.
(60) Provisional application No. 62/879,382, filed on Jul. 26, 2019.

(51) Int. Cl. G01S 7/4863; G01S 7/481; G01S 7/4914; G02B 27/42

(52) U.S. Cl. CPC G01S 7/4863; G01S 7/4816; G02B 27/4272; G01S 7/4914; G01S 7/4817

(57) ABSTRACT

A LiDAR system includes a focal plane array (FPA) system. The FPA system includes a coherent pixel array (CPA) and a diffraction grating stack (DGS). The CPA includes coherent pixels (CPs), and the CPs are configured to emit coherent light. The DGS includes at least one diffraction grating that is positioned to diffract coherent light emitted from the CPA into an environment as one or more light beams. The one or more light beams is emitted at a specific angle and the specific angle is based in part on positions of the CPs that generated the coherent light that form the one or more beams.

### CROSS-REFERENCE TO RELATED APPLICATIONS

This application is a continuation of International Application No. PCT/US2020/043556 filed Jul. 24, 2020, which claims the benefit of and priority to two U.S. Provisional Applications including U.S. Provisional Application 62/879,382 filed Jul. 26, 2019 and U.S. Provisional Application 62/879,383 filed Jul. 26, 2019. The entire disclosures of International Application No. PCT/US2020/043556, and U.S. Provisional Patent applications 62/879,382, and 62/879,383 are hereby incorporated by reference as if fully set forth herein.

### TECHNICAL FIELD

This disclosure relates generally to frequency modulated continuous wave (FMCW) light detection and ranging (LiDAR), more particularly, to focal plane array systems for FMCW LiDAR systems.

### BACKGROUND INFORMATION

Conventional LiDAR systems use mechanical moving parts and bulk optical lens elements (i.e., a refractive lens system) to steer the laser beam. And for many applications (e.g., automotive) are too bulky, costly, and unreliable.

### BRIEF SUMMARY OF THE INVENTION

A lens-free (Focal Plane Array) FPA system for a LiDAR system. The LiDAR system may be, e.g., a frequency modulated continuous wave (FMCW) LiDAR system. The FPA system emits one or more beams of light into an environment. The one or more beams reflect and/or scatter off of objects in the environment and are detected by the FPA system. The LiDAR system used the detected return light to generate depth information describing the environment. The FPA system includes a coherent pixel array (CPA) and a diffraction grating stack (DGS). The CPA includes a plurality of coherent pixels (CPs). The CPs may be arranged in 1D or 2D arrays. A CP emits coherent light and also receives return light. The DGS includes one or more diffraction gratings arranged in series. The DGS may be comprised of thin aperiodic diffraction gratings which collimate light emitted by each CPA in the CPA array. The DGS directs coherent light emitted by the CPA into an environment as one or more light beams. In some embodiments, the DGS also collimates the light emitted from the CPs of the CPA. Each of the one or more light beams is emitted at a specific output angle and the specific output angle is based in part on positions of the CPs that generated the coherent light that form the one or more beams. In some embodiments, the specific output angle is unique for each CP, such light from each CP is output by the DGS as a light beam at an angle unique to that CP.

The FPA system may scan the one or more beams in 1D and/or 2D by selectively activating different CPs of the CPA. Depending on the position of the pixel in the CPA, the collimated beam leaving the DGS propagates at a different output angle. Accordingly, each CP has a unique position relative to the DGS, and in some embodiments the DGS is positioned to diffract coherent light emitted from each respective CP to form a corresponding light beam that is output at a unique angle from the DGS. This effect enables the LiDAR beam to be steered across the environment being probed. As such the FPA system may be configured to scan one or more light beams over some (e.g., a portion of) or all of a field of view of the FPA system. The FPA system may scan the one or more light beams in one or two dimensions. Reciprocally, a beam of light propagating into the DGS at a specific return angle is focused by the DGS to a spot on the CPA. For example, the CP that emitted the beam may be the CP that receives the reflected/scattered beam.

In some embodiments, the FPA system includes an optical element (e.g., array of microprisms, blazed grating, etc.) to convert off-axis light emitted from CPs of the CPA to on-axis light (e.g., primary emission axis is substantially perpendicular to the CPA array). In this manner, off-axis light emitted from a CP can be refracted to emit on-axis, and the on-axis light is provided to the DGS. And reciprocally, reflected light from the local environment may be detected at the CP after passing through the DGS and the optical element).

In some embodiments, a FMCW LiDAR system includes a FPA system. The FPA system comprising a CPA and a DGS. The CPA includes CPs and each of the CPs is configured to emit coherent light. The DGS includes at least one diffraction grating that is positioned to diffract coherent light emitted from the CPA into an environment as one or more light beams. And each of the one or more light beams is emitted at a specific angle and the specific angle is based in part on positions of the CPs that generated the coherent light that form the one or more beams.

In some embodiments, a DGS of a FMCW LiDAR system is described. The DGS includes at least one diffraction grating that is positioned to diffract coherent light emitted from coherent pixels (CPs) of a coherent pixel array(CPA) into an environment as one or more light beams, and each of the one or more light beams is emitted at a specific angle and the specific angle is based in part on respective positions of the CPs that generated the coherent light that form the one or more beams.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified.

FIG. 1 shows a diagram of a FPA system for LiDAR beam steering applications based on the combination of a CPA with a DGS, according to some embodiments.

FIG. 2 depicts a LiDAR system that includes an FPA system, according to one or more embodiments.

FIG. 3 is a FPA that includes a DGS that includes blazed gratings with non-uniform grating periodicities, according to one or more embodiments.

FIG. 4 is a FPA that includes a DGS that includes numerically designed multi-step gratins, according to one or more embodiments.

FIG. 5 is a diagram of a microprism array positioned on top of a CPA, according to one or more embodiments.

FIG. 6 is a diagram of a blazed grating positioned on top of a CPA, according to one or more embodiments.

FIG. 7 shows examples microprism arrays (or equivalently the blazed gratings) that are arranged in two dimensions, according to one or more embodiments.

FIG. 8 illustrates an embedded version of an optical element, according to one or more embodiments.

FIG. 9 shows a schematic of a Switchable Coherent Pixel Array FMCW LiDAR chip, according to one or more embodiments.

FIGS. 10a-d shows four versions of coherent pixels, according to one or more embodiments.

### DETAILED DESCRIPTION

A LiDAR system determines depth information (e.g., distance, velocity, acceleration, for one or more objects) for a field of view of the system. The LiDAR system may be a FMCW LiDAR system. The LiDAR system includes a FPA system.

The FPA system emits one or more beams of light into an environment. The FPA system may be configured to scan one or more light beams over some (e.g., a portion of) or all of a field of view of the FPA system. The FPA system may scan the one or more light beams in one or two dimensions. The FPA system does not use lenses to steer and/or shape the one or more beams. The one or more beams reflect and/or scatter off of objects in the environment and are detected by the FPA system. The FPA system includes the switchable CPA and a DGS. The CPA includes CPs and each of the CPs is configured to emit coherent light. The DGS includes one or more diffraction gratings (e.g., aperiodic) that are arranged in series. Additionally, in some embodiments, the DGS may also include additional diffraction gratings that are arranged in parallel. The one or more diffraction gratings are positioned to direct (e.g., via diffraction) coherent light emitted from the CPA into an environment as one or more light beams. In some embodiments, the DGS also collimates the light emitted by the CPs. And each of the one or more light beams is emitted at a specific angle and the specific angle is based in part on positions of the CPs that generated the coherent light that form the one or more beams. Accordingly, each CP has a unique position relative to the DGS, and in some embodiments the DGS is positioned to diffract coherent light emitted from each respective CP to form a corresponding light beam that is output at a unique angle from the DGS. As such, the FPA system may scan the one or more beams in 1D and/or 2D over a field of view by selectively activating different CPs of the CPA. The return light is incident at the DGS at specific return angles, and the DGS directs the return light to particular CPs as a function of the return angle of the return light. Accordingly, if output angle of a beam composed of light from a CP matches the return angle of return light, the DGS directs the return light to that same CP.

In some embodiments, the FPA system also includes an optical element (e.g., array of microprisms, blazed grating, etc.) to convert off-axis light emitted from CPs of the CPA to on-axis light (e.g., light whose primary emission axis is substantially perpendicular to the CPA). In some embodiments, the light propagating perpendicular to the CPA is substantially parallel to with an optical axis of the CPA. In this manner, off-axis light emitted from a CP can be refracted to emit on-axis, and the on-axis light is provided to the DGS. And reciprocally, reflected light from the local environment may be detected at the CP after passing through the DGS and the optical element). The optical element may be positioned between the CPA and the DGS, the optical element positioned to redirect the off-axis light emitted by the CP such that it is on-axis, wherein on axis light is substantially parallel with an optical axis of the CPA.

The CPs generate one or more output signals using the return light. The one or more output signals are used to determine depth information for the field of view of the LiDAR system. Depth information describes ranges to various surfaces within the field of view of the LiDAR system and may also include information describing velocity of objects within the field of view of the LiDAR system.

Note that the FPA system can steer the light in at least one dimension. And in some embodiments, the CPs are arranged in two-dimensions such that the FPA system can steer the optical beam two-dimensions. Being able to steer the beam without moving parts may mitigate form factor, cost, and reliability issues found in many conventional mechanically driven LiDAR systems. Moreover, the DGS if the FPA system is a cost effective, light and small form-factor alternative to lenses in a FPA-based LiDAR system. Furthermore, the DGS adds additional degrees of freedom beyond what conventional lenses provide, potentially enabling higher performance than could otherwise be achieved.

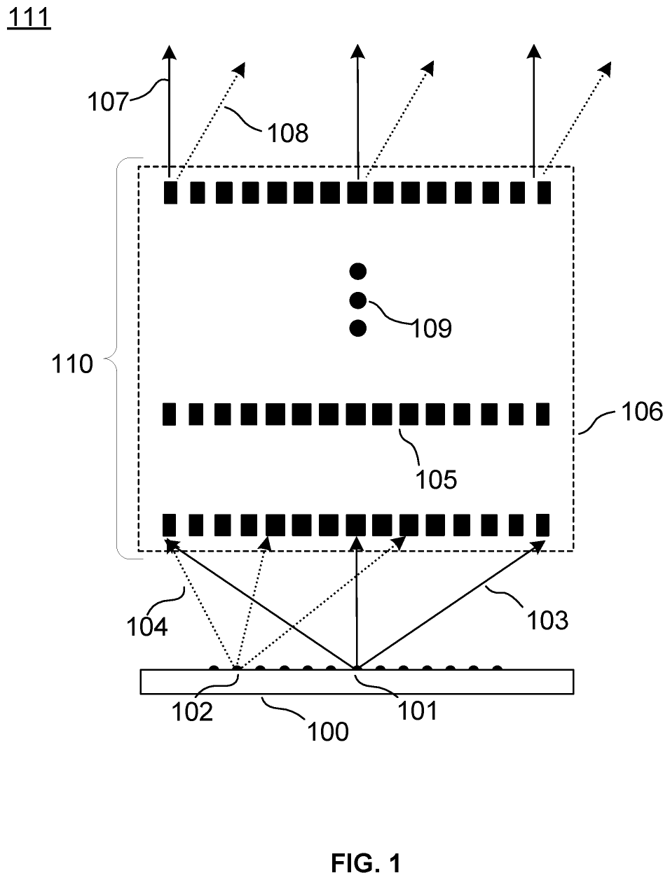

FIG. 1 shows a diagram of a FPA system 111, according to some embodiments. The FPA system 111 includes for LiDAR a CPA 100 and a DGS 110. The CPA 100 includes a plurality of CPs 102. The CPA 100 may be, e.g., a 1D or 2D array of individual CPs. Each CP emits a beam of light vertically towards the DGS 110, and this beam's properties may differ depending on the CP's location (e.g., as depicted by beams 103 and 104). The beams 103, 104 propagate through the DGS 110, exiting at respective angles which depend on the source CP's location in the CPA 100. For example, when the CP 101 is turned on, the DGS 110 converts the incident beam 103 into a collimated exiting beam 107 (depicted using solid lines). In contrast, light from CP 102 is shown as the beam 104 which the DGS 110 outputs as collimated exiting beam 108 (depicted using dashed lines). At any given time, one or more CPs may be enabled in the array.

The DGS 110 is comprised of one or more aperiodic diffraction gratings 105. While generally the DGS 110 includes a plurality of aperiodic diffraction gratings 105. In some embodiments with a small number of CPs positioned near a central axis of the DGS 110, a single aperiodic diffraction grating may be used. Aperiodic diffraction gratings 105 within the DGS 110 may be arranged in series and/or in parallel. For example, FIG. 1 illustrates a plurality of aperiodic diffraction gratings 105 in series. In other embodiments, the DGS 110 may include a plurality of aperiodic diffraction gratings that are in parallel and at least some of the plurality of aperiodic diffraction gratings are also in series. For example, the DGS 110 may include a central region centered on the optical axis of the DGS 110, and the central region is surrounded by peripheral region. In some embodiments, the central region may include a first set of one or more aperiodic diffraction gratings, and the peripheral region may include a different set of aperiodic diffraction gratings that are in series with each other. Such an arrangement may allow light passing through the peripheral region to be manipulated in a different way than light passing through the center region. For example, the center region may produce a small range of beam angles (e.g., output beam angles) than a range of beam angles produced by the peripheral region. In another embodiment, a number of aperiodic diffraction gratings in the center region is greater than of the peripheral region. This may be useful to, e.g., improve the aperture for beams emitted from CPs near the center region in a cost effective manner.

These diffraction gratings may have a continuously modulated phase or a discrete set of phase levels. The gratings 105 may be fabricated out of a lower index material like glass or a higher index material such as silicon or other semiconductors. The gratings may take a variety of forms such as surface relief gratings, sinusoidal gratings, blazed gratings, step gratings, or some combination thereof. They may be fabricated using nano-imprint lithography, deep ultra violet lithography, or other fabrication techniques available to those skilled in the art. In embodiments where there are a plurality of diffraction gratings in the DGS 110, the gratings may be separated by a medium 106. This medium may be air or another higher index material such as a polymer or glass, as required by the system parameters. The one or more aperiodic diffraction gratings 105 are arranged in series with each other and the CPA 100.

Those skilled in the art can design the diffraction gratings of the DGS 110 to maximize power coupled from different CPs in the CPA 100 into collimated beams. Note that the FPA system 111 in FIG. 1 is showing light emitting from the FPA system 111 into an environment, and the light may be reflected/scattered from the environment back to the FPA system 111 as return light (not shown). In some embodiments, the DGS 110 is such that the return light is returned to the emitting CP (e.g., return light from the beam 107 is detected by the CP 101, and return light corresponding to the beam 108 is detected by the CP 102). For example, in the transmit direction, light emitted by a CP will pass through the DGS 110. As the beam propagates through the stack and diffracts, it is molded into a collimated beam at a particular angle (e.g., output beam angle). When this beam reflects off of a (diffuse) surface, the light returns to the DGS at the same angle (e.g., the return beam angle) as return light, and thus along the return path there is an approximate “collimated” wave hitting the DGS 110. In the return direction, the DGS 110 focuses the return light back onto the CP in a reciprocal manner. And in cases where the reflecting surface is an ideal retroreflector, the return light is almost perfectly refocused onto the emitting CP. Accordingly, each emitting CP also detects return light it emitted—which is referred to herein as a “reciprocal system.” In this manner, one or more CPs emit light that the DGS 110 diffracts to one or more light beams and the DGS 110 diffracts the corresponding return light to the one or more CPs. Those skilled in the art can design the gratings in the DGS to work optimally for all CPs in the CPA.

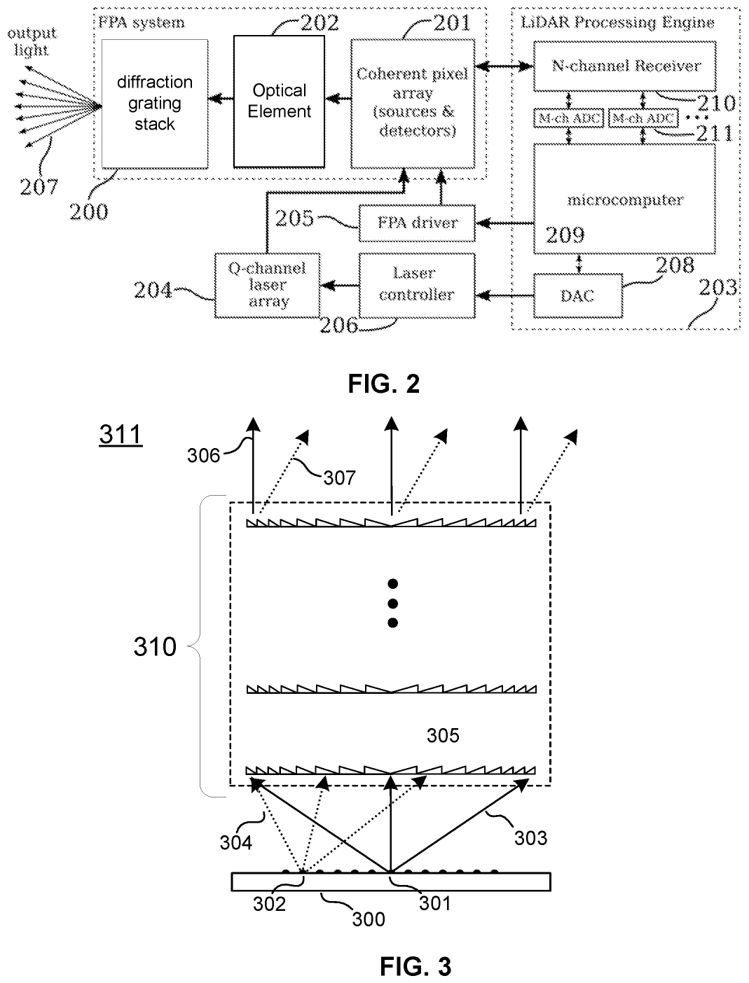

FIG. 2 depicts a LiDAR system containing an FPA system, according to one or more embodiments. The FPA system may be the FPA system 111 described above with reference to FIG. 1. For example, the FPA system may be a reciprocal system. The FPA system includes a DGS 200, an optional optical element 202, and a CPA 201. The DGS 200 may be substantially the same as the DGS 110, and the CPA 201 may be substantially the same as the CPA 100. In FIG. 2, the DGS 200, takes input from the CPA 201 which may optionally employ an optical element 202 (e.g., a prism, microprism array, diffraction grating, etc.) to correct an output beam angle. Note in some cases, the optical element 202 may be such that the CPA 201 is embedded within it (e.g., as discussed below with regard to FIG. 8). The DGS 200 outputs beams with a range of angles 207. The CPs in the CPA 201 are controlled by an FPA driver 205. One or more individual CPs in the CPA 201 may be activated to emit and receive light. Light emitted by the CPA 201 is produced by a Q-channel laser array 204. The Q-channel laser array 204 is a laser array that has Q parallel channels, where Q is an integer. The Q-channel laser array 204 may be integrated directly with the CPA 201 or may be a separate module packaged alongside the CPA 201. The Q-channel laser array 204 is controlled by a laser controller 206. The laser controller 206 receives control signals from a LiDAR processing engine 203, via a digital to analog converter 208. The processing also controls the FPA driver 205 and sends and receives data from the CPA 201.

The LiDAR processing engine 203 includes a microcomputer 209. The microcomputer 209 processes data coming from the FPA system and sends control signals to the FPA system via the FPA driver 205 and laser controller 206. The LiDAR processing engine 203 also includes a N-channel receiver 210. Signals are received by the N-channel receiver 210, and the signals are digitized using a set of M-channel analog to digital converters (ADC) 211.

FIG. 3 is a FPA system 311 that includes a DGS 310 that includes blazed gratings with non-uniform grating periodicities, according to one or more embodiments. The FPA system 311 is an embodiment of the FPA system 111. The FPA 311 includes a CPA 300, and a DGS 310. Note, while not shown, the FPA 311 may also include an optical element (e.g., a prism, prism array, or separate diffraction grating) between the CPA 300 and the DGS 310 that converts off-axis light emitted from CPs of the CPA to on-axis light (e.g., light whose primary emission axis is perpendicular to the CPA). In some embodiments, the light propagating perpendicular to the CPA is substantially parallel to with an optical axis of the CPA. The optical element may also refract on-axis return light (portion of beam reflected from environment) such that it is off-axis light. As illustrated, a CP 301 emits an expanding beam of light 303, which propagates through the DGS 310. The DGS 310 includes a plurality of blazed gratings 305 that are arranged in series. The plurality of blazed gratings 305 produce a collimated beam of light 306 propagating vertically out of the DGS 310. In this embodiment, each of the blazed gratings have a periodicity which evolves monotonically (i.e., generally increases—but can remain constant at certain portions, but does not decrease) with distance from a center of the grating so as to mimic the behavior of a conventional bulk-optical lens element. Note conventional bulk-optical lens elements have a number of disadvantages (e.g., relatively heavier, larger form factor, more expensive) when compared with the embodiments of DGS described herein. Similarly, a second CP 302 located off-center in the CPA 300, emits a beam of light 304 which propagates through the DGS 310, which converts the light into an angled collimated beam of light 307. Note that light from different CPs have different beam angles (e.g., output beam angles) at the output of the DGS 310. Accordingly, the FPA system can steer a beam through an environment by selectively activating different CPs.

Note FIG. 3 is showing light emitting from the FPA system 311 into the environment, and the light may be reflected/scattered from the environment back to the FPA system 311 as return light (not shown). In some embodiments, the stack of blazed gratings 305 are designed to be a reciprocal system such that the return light is returned to the emitting CP (e.g., return light from the beam 306 is detected by the CP 301, and return light corresponding to the beam 307 is detected by the CP 302).

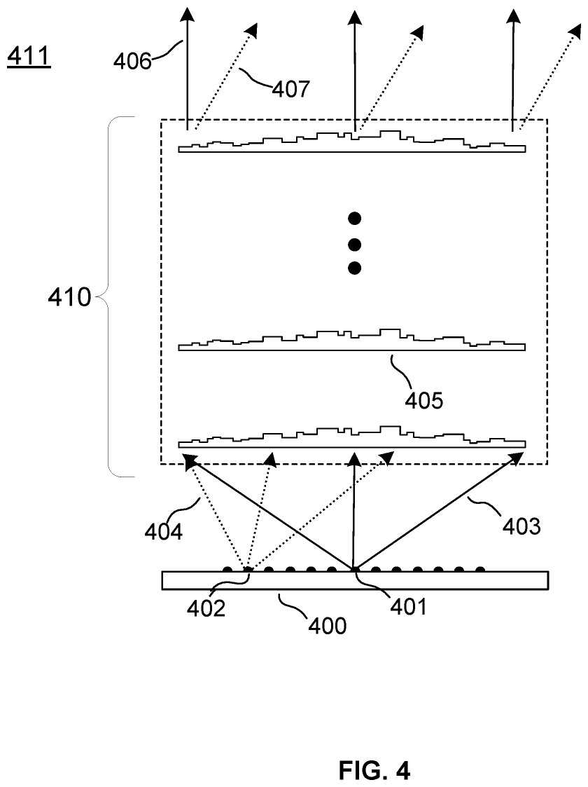

FIG. 4 is a FPA system 411 that includes a DGS 410 that includes numerically designed multi-step gratins, according to one or more embodiments. The FPA system 411 is an embodiment of the FPA system 111. The FPA 411 includes a CPA 400, and a DGS 410. Note, while not shown, the FPA system 411 may also include an optical element (e.g., a prism, prism array, or separate diffraction grating) between the CPA 400 and the DGS 410 that converts off-axis light emitted from CPs of the CPA to on-axis light (e.g., whose primary emission axis is substantially perpendicular to the CPA). In some embodiments, the light propagating perpendicular to the CPA is substantially parallel to with an optical axis of the CPA. The optical element may also refract on-axis return light (portion of beam reflected from environment) such that it is off-axis light. As illustrated, a CP 401 emits an expanding beam of light 403, which propagates through the DGS 410. The DGS 410 includes a plurality of multistep gratings 405 that are arranged in series. The multistep gratings have a non-trivial distribution of thicknesses which can be designed using numerical optimization methods. Similarly, a second pixel located off-center in the CPA 402, emits a beam of light 404 which propagates through the DGS 410. The DGS 410 converts the light into an angled collimated beam of light 407.

Note FIG. 4 is showing light emitting from the FPA system 411 into the environment, and the light may be reflected/scattered from the environment back to the FPA system 411 as return light (not shown). In some embodiments, the DGS 410 is a reciprocal system such that the return light is returned to the emitting CP (e.g., return light from the beam 406 is detected by the CP 401, and return light corresponding to the beam 407 is detected by the CP 402).

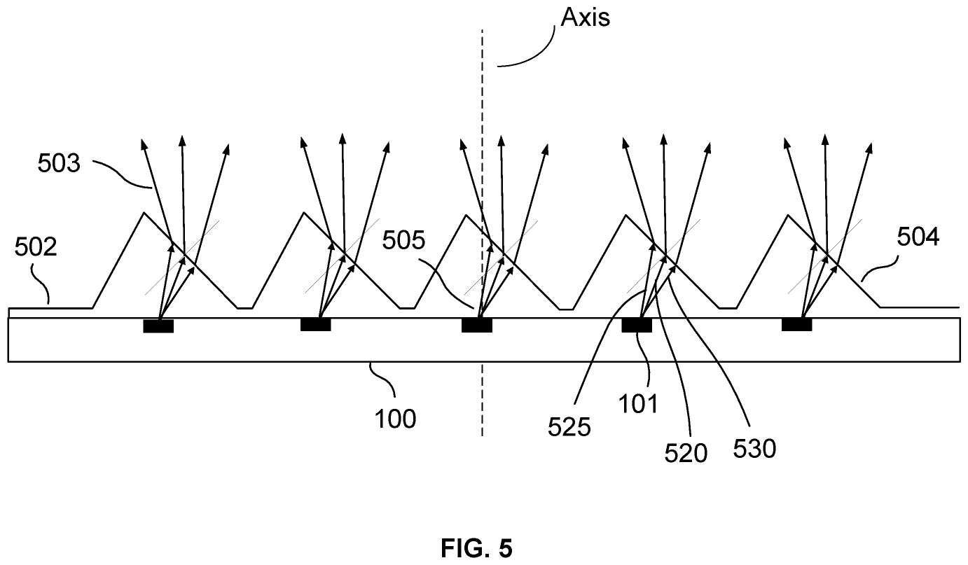

FIG. 5 is a diagram of a microprism array 502 positioned on top of the CPA 100, according to one or more embodiments. The microprism array 502 is an embodiment of the optical element 202. The microprism array 502 includes an arrangement of transparent (over at least the band of light emitted by the CPA 100) triangular elements made out of a material whose refractive index is higher than the refractive index of a surrounding medium (e.g., air). The CPA 100 includes of an array of individual CPs. As described above, the CPs of the CPA 100 can be turned on and off either one at a time and/or in groups.

Each CP includes an emission area that emits light according to an emission distribution. For example, the CP 101 has an emission distribution that has a primary emission axis 520 and off-axis boundaries 525 and 530. The primary emission axis 520 is a direction that the emission area emits light with the most intensity. The emission distribution may be rotationally symmetric or rotationally asymmetric around the primary emission axis 520.

As illustrated, each CP emits a beam of light whose primary emission axis at an angle 505—as such the light emitted by each of the CPs is off-axis light. Off-axis light is light whose primary emission axis is not parallel with an axis that runs perpendicular to the CPA 100. In some embodiments, the axis may be an optical axis of the FPA system. In contrast, on-axis light is light whose primary emission axis is substantially parallel with the axis. Note as illustrated the angle 505 is the same for each CP, but in other embodiments, some or all of the angles may be different from each other. Each microprism of the microprism array 502 includes one or more facets 504. Each CP is overlaid with at least one facet of a microprism. Note in some embodiments, a single microprism may overlay multiple CPs. The microprisms are configured (e.g., via material of microprism and shape of the one or more facets 504) to refract incident light such that off-axis is redirected to be on-axis, and likewise, on-axis light (i.e., return light) is redirected to be off-axis light (such that it is incident on a CP).

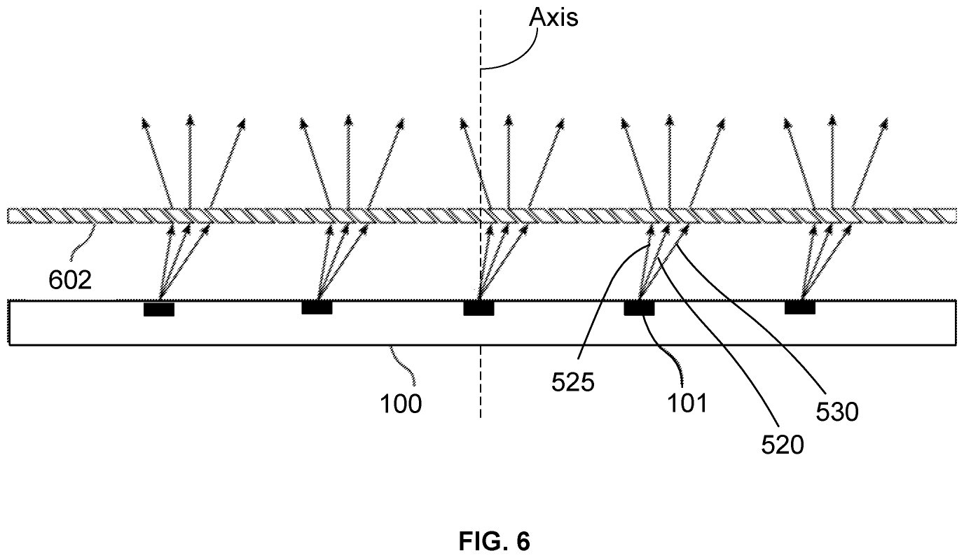

FIG. 6 is a diagram of a blazed grating 602 positioned on top of the CPA 100, according to one or more embodiments. The blazed grating 602 is an embodiment of the optical element 202. The blazed grating 602 implements the same functionality as the microprism array 502, except that it operates under the principles of diffraction instead of refraction.

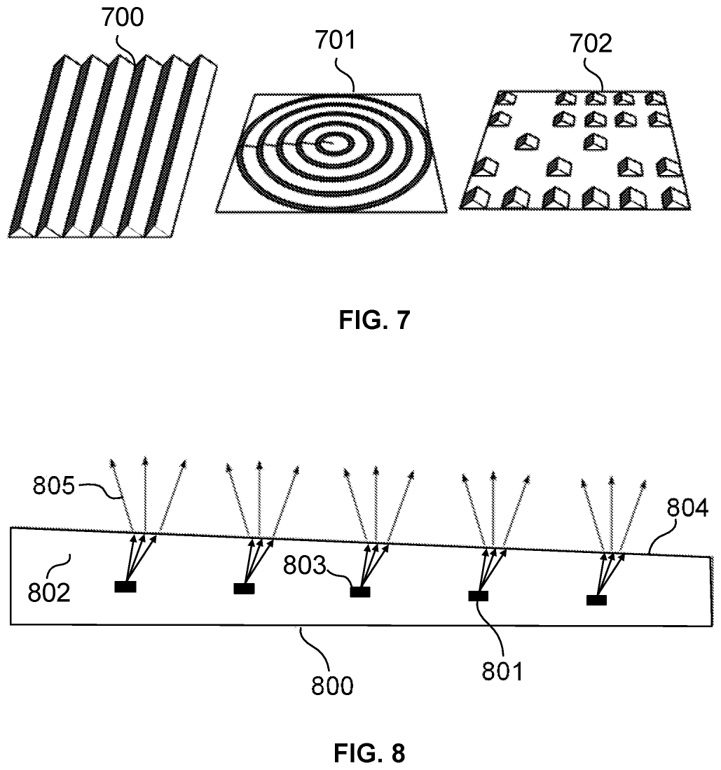

FIG. 7 shows examples microprism arrays (or equivalently the blazed gratings) that are arranged in two dimensions, according to one or more embodiments. The microprism arrays may be an embodiment of the optical element 202 and/or the microprism array 502. In 700, the microprism array is laid out in a 1D linear array, which is compatible with a regular grid of identically-angled CPs. In 701, the microprism array is radially-symmetric, which is compatible with a radially-symmetric grid of CPs. In 702, the position and orientation of the microprisms is arbitrary, which is compatible with an arbitrary arrangement of CPs. For example, each microprism shown in 702 may cover one or more corresponding CPs, and in some cases each microprism in 702 covers a single corresponding CP. In all three examples, the outgoing beams propagate at the same on-axis angle.

FIG. 8 illustrates an embedded version of an optical element, according to one or more embodiments. In this case, a coherent pixel array 800 (e.g., an embodiment of the CPA 100) includes CPs 801 that are embedded in a high index medium 802. The optical element is a monolithic material that overmolds the coherent pixel array 800, and a surface 804 of the monolithic material is at an angle relative to the CPs 801 such that the light emitted by the CPs 801 is refracted to be on-axis. The CPs emit beams of light 803 which propagate at a small angle. The beams impinge on a surface 504 which is polished and at a small angle such that a transmitted beam 805 propagates vertically (i.e., is substantially on-axis). In other embodiments, the angle of the surface may be such that the transmitted beam 8-5 is emitted at some other target angle.

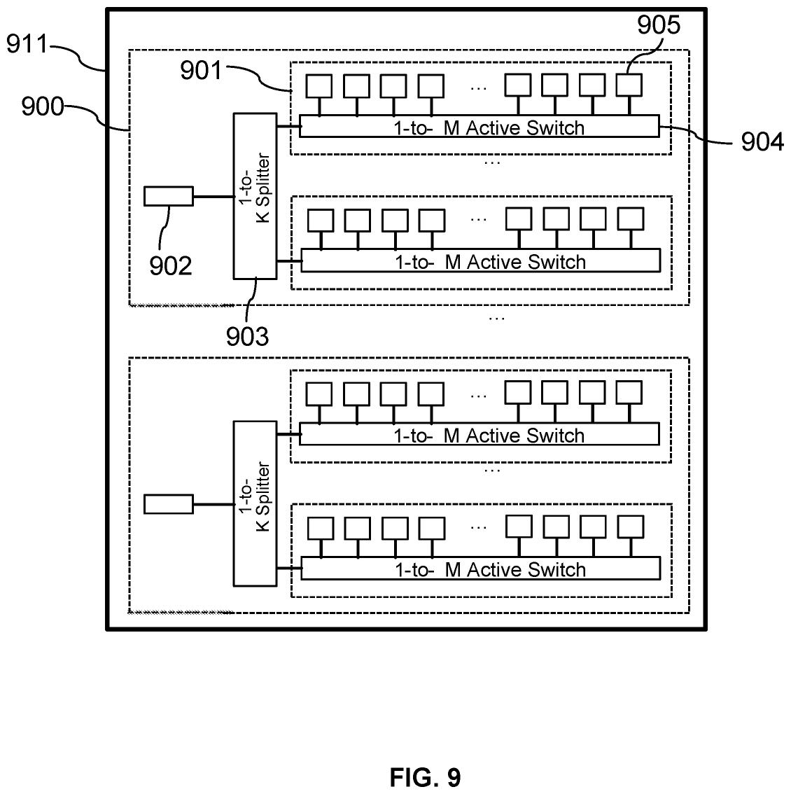

FIG. 9 shows a schematic of the Switchable Coherent Pixel Array (SCPA) FMCW LiDAR chip 911, according to one or more embodiments. The LiDAR chip is a photonic integrated circuit. The chip can include a plurality of basic functional subarrays 900. Each subarray 900 includes an optical input/output (I/O) port 902 and an optional 1-to-K optical splitter 903, where K is an integer, and one or more SCPAs 901. The 1-to-K optical splitter 903 may be passive or active. Each of the optical I/Os is fed by a frequency-modulated light source provided by an off-chip or on-chip laser. The optical power can be distributed on-chip through the optional 1-to-K optical splitter to reduce the number of optical I/Os. In the illustrated embodiment, the respective outputs of the 1-to-K optical splitter 903 feeds a corresponding SPCA 901. In the illustrated embodiments, each SCPA 901 includes M coherent pixels 905 and an optical switch network 904, where M is an integer. Note that in some instances one or more of the optical switch networks 904, the optional 1-to-K optical splitter 903, or some combination thereof, may be referred to simply as an optical switch. The optical switch is configured to switchably couple the input port 902 to the optical antennas within the coherent pixels, thereby forming optical paths between the input port and the optical antennas. The optical switch may include a plurality of active optical splitters. In some embodiments, the optical switch optically couples the frequency modulated laser signal to each of the optical antennas one at time over a scanning period of the FMCW transceiver.

The optical switch network 904 selects one or more of the M coherent pixels to send and receive the Frequency Modulated (FM) light for ranging and detection. The coherent pixels can be physically arranged in either one-dimensional (e.g., linear array) or two-dimensional arrays (e.g., rectangular, regular(e.g., non-random arrangement like a grid)) on the chip. In some embodiments, the selected coherent pixel is able to transmit the light into free space, receive the returned optical signals, perform coherent detection and convert optical signals directly into electrical signals for digital signal processing. Note that the received optical signals do not propagate through the switch network again in order to be detected, and instead outputs are separately routed (not shown in the illustrated embodiment), which reduces the loss and therefore improves the signal quality.

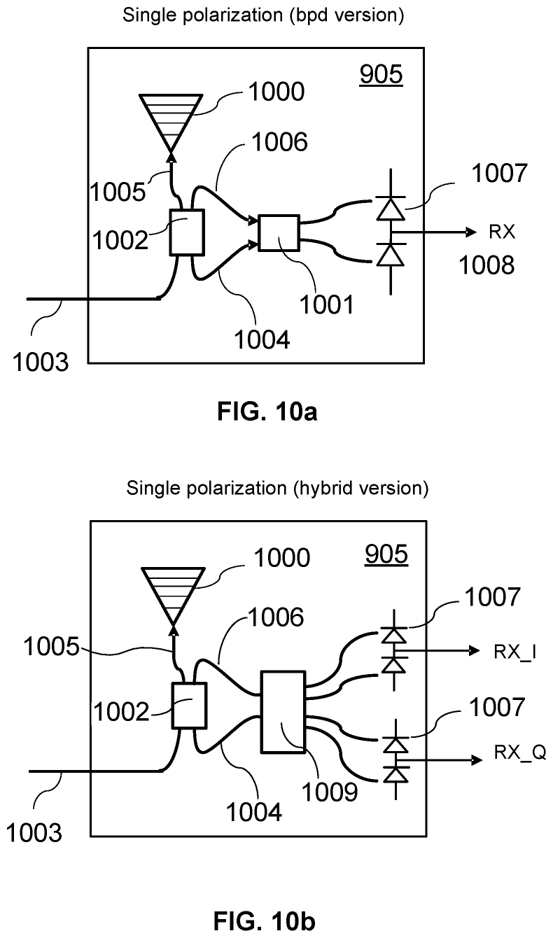

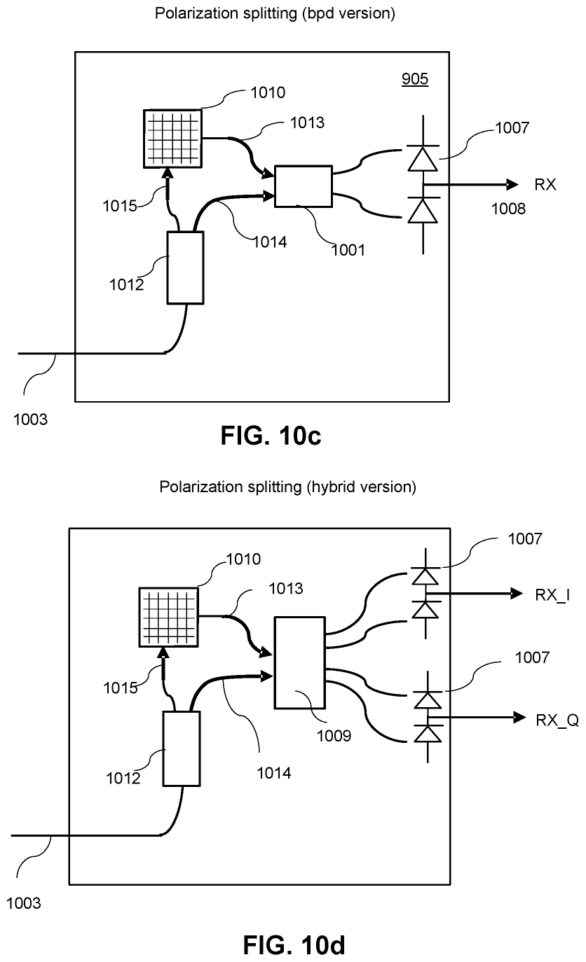

FIGS. 10a-d shows four versions of coherent pixels, according to one or more embodiments. The four versions of coherent pixels may be, e.g., embodiments of the coherent pixels described above in FIG. 9. In FIGS. 10a and 10b, light from the optical switch network (e.g., the optical switch network 904) is provided to an optical input port 1003 of the coherent pixel. A bi-directional optical 2×2 splitter 1002 splits the light into 2 output ports, referred two as TX Signal 1005 and Local Oscillator, LO 1006. TX Signal 1005 is sent out of the chip using an optical antenna 1000. The optical antenna is a device that emits light from on-chip waveguides into free space or couples light from free space into on-chip waveguides, such as a grating coupler, an edge coupler, an integrated reflector or any spot-size converters. The optical antenna is typically polarization-sensitive with much higher emission/coupling efficiency for light with one particular polarization (e.g. TE). The antenna is reciprocal and therefore it collects the reflected beam from the object under measurement and sends it back to the bi-directional 2×2 splitter 1002, which in turn splits it between ports 1004 and 1006. The bi-directional optical 2×2 splitter 1002 functions as a “pseudo-circulator” in this monostatic configuration where the transmitter and receiver are collocated. The received signal out of port 1004 and LO 1006 are mixed for coherent detection by an optical mixer, which can be a balanced 2×2 optical combiner 1001 as in FIG. 10a or an optical hybrid 1009 as in FIG. 10b. Finally, a pair of Photo-Diodes (PDs) 1007 in FIG. 10a and 4 PDs in FIG. 10b convert the optical signals into electrical signals for beat tone detection. The version in FIG. 10a is referred to as the Balanced Photo-Diode (BPD) version and the one in FIG. 10b as the hybrid version. The hybrid version provides in-phase and quadrature outputs (I/Q), which can be used to resolve velocity-distance ambiguities or enable advanced DSP algorithms in an FMCW LiDAR system. Using bi-directional optical 2×2 splitter as the “pseudo-circulator” may eliminate having a discrete circulator for every single pixel which is impractical for large-scale arrays with hundreds of pixels. Accordingly, the coherent pixels may reduce cost and form factor significantly with a signal-to-noise ratio (SNR) penalty up to 6 dB (as some of the guided optical power cannot be used for coherent detection). For example, the received optical signal may be divided between the port 1003 and the port 1004, of which the latter is used for coherent detection. The coherent pixel designs, shown in FIG. 10c and FIG. 10d, address this limitation by introducing a polarization splitting antenna 1010 into the new structure. Light from the optical switch network is provided to the optical input port 1003 of the coherent pixel. An optical splitter 1012 splits the light into 2 output ports, referred two as TX Signal 1015 and Local Oscillator, LO 1014. TX Signal 1015 is sent out of the chip directly using a polarization splitting optical antenna 1010 with one polarization (e.g. TM). The antenna collects the reflected beam from the object under measurement, couples the orthogonal polarization (e.g. TE) into the waveguide 1013 and sends it directly to the optical mixer. In this case, the optical signal received by the antenna is not further divided by any additional splitters or the “pseudo-circulator.” The received signal out of port 1013 and LO 1014 are mixed for coherent detection by an optical mixer, which can be a balanced 2×2 optical combiner 1001 as in FIG. 10c or an optical hybrid 1009 as in FIG. 10d. Finally, a pair of Photo-Diodes (PDs) 1007 in FIGS. 10c and 4 PDs in FIG. 10d convert the optical signals into electrical signals for beat tone detection. This design realizes a highly efficient integrated circulator for every single coherent pixel and enables on-chip monostatic FMCW LiDAR with ultrahigh sensitivity. The details will be further discussed in FIGS. 8 to 10. In some embodiments, in the context of FIG. 2, the coherent pixels of FIGS. 10a-d are such that each of the plurality of optical antennas has a separate splitter, and each splitter is coupled along a respective optical path between the optical switch and the corresponding antenna.

### Additional Configuration Information

The figures and the preceding description relate to preferred embodiments by way of illustration only. It should be noted that from the preceding discussion, alternative embodiments of the structures and methods disclosed herein will be readily recognized as viable alternatives that may be employed without departing from the principles of what is claimed.

Although the detailed description contains many specifics, these should not be construed as limiting the scope of the invention but merely as illustrating different examples. It should be appreciated that the scope of the disclosure includes other embodiments not discussed in detail above. Various other modifications, changes and variations which will be apparent to those skilled in the art may be made in the arrangement, operation and details of the method and apparatus disclosed herein without departing from the spirit and scope as defined in the appended claims. Therefore, the scope of the invention should be determined by the appended claims and their legal equivalents.

Alternate embodiments are implemented in computer hardware, firmware, software, and/or combinations thereof. Implementations can be implemented in a computer program product tangibly embodied in a machine-readable storage device for execution by a programmable processor; and method steps can be performed by a programmable processor executing a program of instructions to perform functions by operating on input data and generating output. Embodiments can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits) and other forms of hardware.

What is claimed is:

1-20. (canceled)

21. A light detection and ranging (LIDAR) system for a vehicle comprising:
a coherent pixel array that includes a plurality of coherent pixels, wherein the plurality of coherent pixels includes a first coherent pixel and a second coherent pixel that are configured to emit coherent lights respectively; and
a diffraction grating stack (DGS) including at least one diffraction grating that is configured to diffract the coherent lights emitted from the coherent pixel array into an environment of the vehicle as one or more light beams, wherein the one or more light beams are emitted at a specific angle and the specific angle is determined based in part on positions of the coherent pixels in the plurality of coherent pixels that generate the coherent lights that form the one or more beams.

22. The LIDAR system for a vehicle of claim 21, wherein the at least one diffraction grating is an aperiodic diffraction grating.

23. The LIDAR system for a vehicle of claim 21, wherein the at least one diffraction grating has a periodicity that evolves monotonically with distance from a center of the at least one diffraction grating.

24. The LIDAR system for a vehicle of claim 21, wherein a first primary emission angle of the first coherent pixel is different than a second primary emission angle of the second coherent pixel.

25. The LIDAR system for a vehicle of claim 21, wherein the at least one diffraction grating is selected from a group comprising: a surface relief grating, a sinusoidal grating, a blazed grating, and a step grating.

26. The LIDAR system for a vehicle of claim 21 further comprising:
an optical element disposed between the coherent pixel array and the DGS, wherein the optical element is configured to correct the coherent lights emitted by the coherent pixels in the plurality of coherent pixels.

27. The LIDAR system for a vehicle of claim 21, wherein the LIDAR system is configured to scan the one or more light beams over a portion of a field of view of the LIDAR system.

28. The LIDAR system for a vehicle of claim 27, wherein the coherent pixel array is a 2D array, and the LIDAR system is configured to scan the one or more light beams in two dimensions.

29. The LIDAR system for a vehicle of claim 21, wherein the one or more light beams reflect off an object in the environment to form return light, and the DGS is positioned to:
diffract the return light to one or more coherent pixels that generated the one or more light beams.

30. The LIDAR system for a vehicle of claim 21, wherein light emitted by the first coherent pixel of the coherent pixel array is off-axis, the LIDAR system further comprising:
an optical element positioned between the coherent pixel array and the DGS, the optical element positioned to redirect the off-axis light emitted by the first coherent pixel such that it is on-axis, wherein on axis light is substantially parallel with an optical axis of the coherent pixel array.

31. The LIDAR system for a vehicle of claim 30, wherein a first light beam of the one or more light beams is formed from light from the first coherent pixel, and the first light beam reflects of an object in the environment to form return light, and the optical element is positioned to receive the return light from the DGS and redirect the received return light to be off-axis, and the off-axis return light is detected at the first coherent pixel.

32. The LIDAR system for a vehicle of claim 30, wherein the optical element is a blazed grating, and the light emitted from the first coherent pixel is diffracted to be on-axis.

33. The LIDAR system for a vehicle of claim 30, wherein the optical element is a monolithic material that overmolds the coherent pixel array, and a surface of the monolithic material is at an angle relative to the first coherent pixel such that the light emitted by the first coherent pixel is refracted to be on-axis.

34. The LIDAR system for a vehicle of claim 30, wherein the optical element is a microprism array.

35. The LIDAR system for a vehicle of claim 34, wherein the microprism array is a linear array of microprisms.

36. The LIDAR system for a vehicle of claim 34, wherein the microprism array is a circular array of microprisms, wherein the microprism form a series of rings, and the plurality of coherent pixels in the coherent pixel array have a radial distribution pattern and a particular microprism overlays the first coherent pixel and the second coherent pixel.

37. The LIDAR system for a vehicle of claim 34, wherein a particular microprism in the microprism array overlays only the first coherent pixel in the coherent pixel array.

38. The LIDAR system for a vehicle of claim 21, wherein light emitted by the coherent pixel array is off-axis, the LIDAR system for a vehicle further comprising:
an optical element positioned between the coherent pixel array and the DGS, the optical element positioned to redirect the off-axis light emitted by the coherent pixel array such that it is on-axis, wherein on axis light is substantially parallel with an optical axis of the coherent pixel array.

39. The LIDAR system for a vehicle of claim 38, wherein the one or more light beams is formed from light from the coherent pixel array, and the one or more beams reflects of an object in the environment to form return light, and the optical element is positioned to redirect the return light received from the DGS to be off-axis, and the off-axis return light is detected at the coherent pixels in the plurality of coherent pixels that generated the one or more beams.

40. A diffraction grating stack (DGS) of a frequency modulated continuous wave (FMCW) light detection and ranging (LIDAR) system, the DGS comprising:
at least one diffraction grating that is positioned to diffract coherent light emitted from coherent pixels of a coherent pixel array into an environment as one or more light beams, wherein the one or more light beams are emitted at a specific angle and the specific angle is based in part on respective positions of the coherent pixels that generated the coherent light that form the one or more beams.
